(19) United States
(12) Patent Application Publication
(10) Pub. No.: US 2026/0170629 A1
(43) Pub. Date: Jun. 18, 2026

(54) INFORMATION PROCESSING APPARATUS, INFORMATION PROCESSING METHOD, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventors: Riki KUDOU, Kawasaki Kanagawa (JP); Ryo KIYAMA, Koza Kanagawa (JP); Kunio BABA, Kawasaki Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/312,327

(22) Filed: Aug. 28, 2025

(30) Foreign Application Priority Data
Dec. 17, 2024 (JP) 2024-221050

(51) Int. Cl. G06T 7/00; G06F 40/166

(52) U.S. Cl. CPC G06T 7/0002; G06F 40/166; G06T 2207/20081; G06T 2207/30168

(57) ABSTRACT

According to one embodiment, an information processing apparatus includes a processor. The processor is configured to acquire a first image including an inspection target, calculate an abnormality score for each region included in the first image by using the first image and an abnormality detection model, generate an abnormality score map in which the abnormality score is assigned to the region, extract a first region from the first image based on the abnormality score map, generate a first text expressing an inside of the first region, specify content of an abnormality occurring in an inspection target based on the first text, and output the content of the abnormality.

### CROSS-REFERENCE TO RELATED APPLICATIONS

This application is based upon and claims the benefit of priority from Japanese Patent Application No. 2024-221050, filed Dec. 17, 2024, the entire contents of which are incorporated herein by reference.

### FIELD

Embodiments described herein relate generally to an information processing apparatus, an information processing method, and a storage medium.

### BACKGROUND

In recent years, for example, from the viewpoint of improving quality control, a technique for automatically detecting an abnormality of an inspection target has been developed. Note that such abnormality detection is also useful for enhancing security, ensuring reliability of an automated system, and the like.

In particular, since an image includes a lot of visual information, abnormality detection using the image is used for product quality inspection, assistance of image diagnosis in the medical field, and the like.

In general, it is conceivable to detect an abnormality of an inspection target from an image by using, for example, an abnormality detection model (trained model) generated by performing supervised learning. However, in order to perform the supervised learning, it is necessary to prepare an image including an inspection target in an abnormal state (hereinafter, referred to as an abnormal image) and an annotation, and as a result, it is difficult to prepare an abnormality detection model.

For this reason, generating an abnormality detection model by performing unsupervised learning (that is, unsupervised abnormality detection) has attracted attention. The unsupervised learning is useful in that an abnormal image is unnecessary because only a normal image is used. The unsupervised learning is also advantageous in that an unknown abnormality can be detected.

However, it is difficult to specify content of an abnormality in the unsupervised abnormality detection, and there is a possibility that sufficient abnormality detection will not be implemented in actual operation.

### BRIEF DESCRIPTION OF THE DRAWINGS

FIG. 1 is a block diagram illustrating an example of a functional configuration of an information processing apparatus according to a first embodiment;

FIG. 2 is a diagram illustrating an example of a hardware configuration of the information processing apparatus;

FIG. 3 is a flowchart illustrating an example of a processing procedure of the information processing apparatus;

FIG. 4 is a diagram for specifically explaining an operation of the information processing apparatus;

FIG. 5 is a diagram for explaining an outline of a second embodiment;

FIG. 6 is a block diagram illustrating an example of a functional configuration of the information processing apparatus;

FIG. 7 is a flowchart illustrating an example of a processing procedure of the information processing apparatus; and

FIG. 8 is a diagram for specifically explaining an operation of the information processing apparatus.

### DETAILED DESCRIPTION

In general, according to one embodiment, an information processing apparatus includes a processor. The processor is configured to acquire a first image including an inspection target, calculate an abnormality score representing a degree of abnormality for each region included in the first image by using the acquired first image and an abnormality detection model generated by performing training on an image including an inspection target in a normal state, generate an abnormality score map in which the calculated abnormality score is assigned to the region, extract a first region from the first image based on the generated abnormality score map, generate a first text expressing an inside of the extracted first region, specify content of an abnormality occurring in the inspection target based on the generated first text, and output the specified content of the abnormality.

Various embodiments will be described with reference to the accompanying drawings.

### First Embodiment

First, a first embodiment will be described. An information processing apparatus according to the present embodiment operates as an abnormality detection apparatus for detecting an abnormality of an inspection target using, for example, an image including the inspection target.

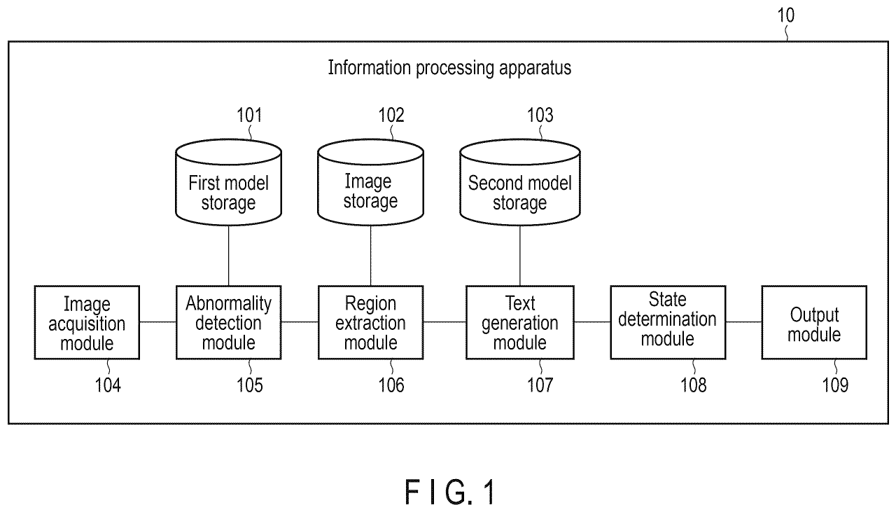

FIG. 1 is a block diagram illustrating an example of a functional configuration of the information processing apparatus according to the present embodiment. As illustrated in FIG. 1, the information processing apparatus 10 includes a first model storage 101, an image storage 102, a second model storage 103, an image acquisition module 104, an abnormality detection module 105, a region extraction module 106, a text generation module 107, a state determination module 108, and an output module 109.

The first model storage 101 stores an abnormality detection model prepared in advance. Note that the abnormality detection model stored in the first model storage 101 is used, for example, to calculate an abnormality score to be described later based on an image including an inspection target.

The image storage 102 corresponds to an image database that stores images prepared in advance. The image stored in the image storage 102 is, for example, an image including an inspection target in a normal state (hereinafter, referred to as a normal image), but may be an image including an inspection target in an abnormal state (hereinafter, referred to as an abnormal image).

The second model storage 103 stores a generation model prepared in advance. Note that the generation model stored in the second model storage 103 is used, for example, to generate a text representing the inside of an image based on the image.

For example, when inspecting a predetermined inspection target, the image acquisition module 104 acquires an image including the inspection target (hereinafter, referred to as an inspection target image). The inspection target image is, for example, an image obtained by imaging the inspection target with a fixed camera, but may be an image obtained by imaging the inspection target with a camera used by a user.

The abnormality detection module 105 calculates an abnormality score corresponding to the inspection target image acquired by the image acquisition module 104 by using the abnormality detection model stored in the first model storage 101, and generates an abnormality score map based on the calculated abnormality score. Note that the abnormality score map corresponds to data in a map format in which an abnormality score indicating a degree of abnormality is assigned to each region (pixel or batch) of the inspection target image. In addition, the abnormality score is, for example, an index that is related to an abnormality and has a larger value as the degree of abnormality increases.

According to the abnormality score map described above, the abnormality detection module 105 can detect that an abnormality has occurred in the inspection target included in the inspection target image based on the abnormality score assigned in the abnormality score map.

However, even in a case where it is detected that an abnormality has occurred in the inspection target as described above, it is difficult to specify content (type) of the abnormality by using the abnormality score map (abnormality detection model).

Further, for example, there is a technique that can provide an answer to a question sentence by using natural language processing (hereinafter, referred to as a question answering technique). In a case where such a question answering technique is applied to abnormality detection, it may be possible to specify the content of the abnormality based on, for example, an answer (response) to a question sentence related to the abnormality occurring in the inspection target included in the inspection target image.

However, in a case where the content of the abnormality is specified from the inspection target image simply by applying the question answering technique, it is necessary to precisely create a question sentence for specifying an occurrence position of the abnormality and the content of the abnormality. As a result, the number of question sentences becomes enormous, and a question design procedure becomes complicated (that is, a cost for designing question sentences is high).

Therefore, the present embodiment provides a mechanism capable of simplifying the above-described question design procedure and specifying the content of the abnormality.

The region extraction module 106 extracts a first region from the inspection target image based on the abnormality score map generated by the abnormality detection module 105. The first region extracted by the region extraction module 106 is a region which is included in the inspection target image and to which a high abnormality score is assigned in the abnormality score map (that is, a region having a high abnormality score), and can be said to be a partial image of the inspection target image.

In addition, the region extraction module 106 acquires a normal image from the image storage 102, and extracts a second region from the normal image. Note that the normal image stored in the image storage 102 is, for example, an image obtained by imaging an inspection target in a normal state with a fixed camera. Further, the second region extracted by the region extraction module 106 is a region having the same range (the position and the size) as the first region described above.

The text generation module 107 generates a first text expressing the inside of the first region by using the first region extracted by the region extraction module 106 and the generation model stored in the second model storage 103. In addition, the text generation module 107 generates a second text expressing the inside of the second region by using the second region extracted by the region extraction module 106 and the generation model stored in the second model storage 103.

Note that the first text is text information indicating an object itself included in the first region (that is, a region having a high abnormality score in the inspection target image) or a state of the object, and the second text is text information indicating an object itself included in the second region (a region in the same range as the first region in the normal image) or a state of the object. In addition, the generation model corresponds to a basic model based on the above-described question answering technique, and it is assumed that the generation model is generated by self-supervised learning using, for example, large-scale data (pairs of images, question sentences, and answers). Here, the generation model may be generated based on another learning method.

The state determination module 108 determines a state of the inspection target included in the inspection target image based on the first text and the second text generated by the text generation module 107. Note that, in the present embodiment, “determining a state of the inspection target” includes specifying the content of the abnormality occurring in the inspection target.

The output module 109 outputs a determination result (that is, the content of the abnormality occurring in the inspection target) by the state determination module 108.

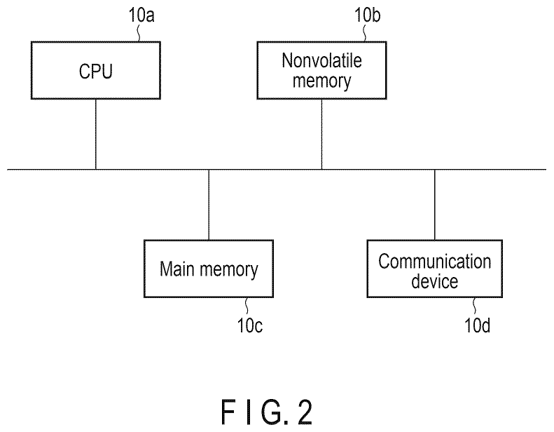

FIG. 2 illustrates an example of a hardware configuration of the information processing apparatus 10 illustrated in FIG. 1. The information processing apparatus 10 includes a CPU 10a, a nonvolatile memory 10b, a main memory 10c, a communication device 10d, and the like.

The CPU 10a is a processor for controlling operations of various components in the information processing apparatus 10. The CPU 10a may be a single processor or may include a plurality of processors. The CPU 10a executes various programs loaded from the nonvolatile memory 10b to the main memory 10c. The programs to be executed by the CPU 10a as described above include, for example, an operating system (OS), an application program, and the like.

The nonvolatile memory 10b is a storage medium used as an auxiliary storage device. The main memory 10c is a storage medium used as a main storage device. Although only the nonvolatile memory 10b and the main memory 10c are illustrated in FIG. 2, the information processing apparatus 10 may include other storage devices.

The communication device 10d is a device configured to perform communication with an external apparatus (for example, a server apparatus or the like).

Note that, in the present embodiment, the first model storage 101, the image storage 102, and the second model storage 103 illustrated in FIG. 1 are implemented by, for example, the nonvolatile memory 10b or another storage device.

Further, some or all of the image acquisition module 104, the abnormality detection module 105, the region extraction module 106, the text generation module 107, the state determination module 108, and the output module 109 included in the information processing apparatus 10 illustrated in FIG. 1 are implemented by causing the CPU 10a (that is, a computer of the information processing apparatus 10) to execute a predetermined program, that is, by software. This program may be distributed by being stored in a computer-readable storage medium, or may be downloaded to the information processing apparatus 10 via a network. Note that some or all of these modules 104 to 109 may be implemented by hardware such as an integrated circuit (IC), or may be implemented by a combination of software and hardware.

Note that, although not illustrated in FIG. 2, the information processing apparatus 10 may further include an input device such as a mouse or a keyboard, and a display device such as a display.

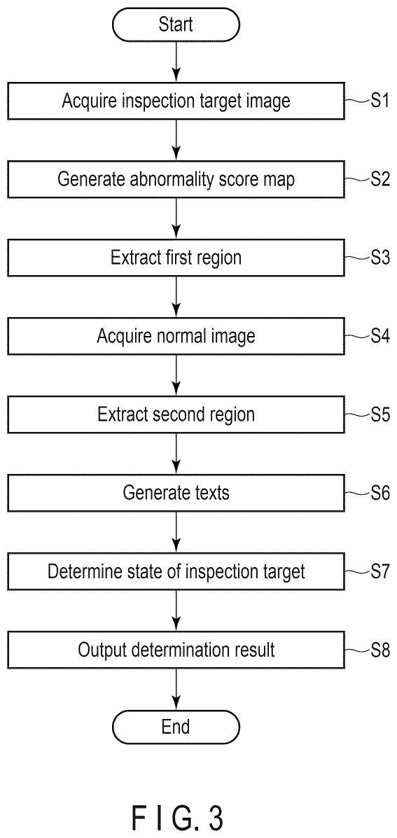

Hereinafter, an example of a processing procedure of the information processing apparatus 10 according to the present embodiment will be described with reference to the flowchart of FIG. 3.

First, the image acquisition module 104 acquires an inspection target image (step S1). Note that, as the inspection target included in the inspection target image in the present embodiment, for example, a product manufactured in a factory is assumed, but the inspection target may be an object or the like in which an abnormality occurs on the appearance (surface) appearing in the image.

When processing of step S1 is executed, the abnormality detection module 105 generates an abnormality score map based on the abnormality score calculated by using the inspection target image acquired in step S1 and the abnormality detection model stored in the first model storage 101 (step S2).

Hereinafter, the processing of step S2 will be described. Here, it is assumed that the abnormality detection model in the present embodiment is, for example, an auto encoder generated by performing learning (unsupervised learning) using a normal image. In this case, the abnormality detection model (auto encoder) is configured to output, when a normal image is input, an image close to the normal image, and output, when an image different from a normal image (for example, an abnormal image) is input, an image different from the input image because an image close to the input image cannot be reconfigured. According to such an abnormality detection model, the abnormality detection module 105 can calculate the abnormality score based on a reconfiguration error between the inspection target image (input image) input to the abnormality detection model and the image (output image) output from the abnormality detection model. Note that the abnormality score is calculated for each region in the inspection target image. Specifically, the abnormality score is calculated in units of pixels or batches included in the inspection target image.

In step S2, the abnormality detection module 105 can generate an abnormality score map by assigning the abnormality score calculated for each region to the corresponding region as described above.

Here, it has been described that the abnormality detection model is an auto encoder and the abnormality score is calculated using the auto encoder. On the other hand, the abnormality detection model in the present embodiment only needs to contribute to generation of the abnormality score map. For example, the abnormality detection model may be a trained model obtained by performing training to output the abnormality score for each region in a case where an inspection target image is input to the abnormality detection model, or may be a trained model obtained by performing training to output an abnormality score map in a case where an inspection target image is input to the abnormality detection model.

Next, the region extraction module 106 extracts a first region from the inspection target image based on the abnormality score assigned to each region in the abnormality score map generated in step S2 (step S3). In step S3, for example, a region to which the abnormality score equal to or higher than a predetermined value is assigned is extracted as the first region.

In addition, the region extraction module 106 acquires a normal image from the image storage 102 (step S4).

Here, assuming that the inspection target image acquired in step S1 is, for example, an image obtained by imaging the inspection target with a fixed camera, the normal image acquired in step S4 is an image obtained by imaging the inspection target (a product similar to the inspection target) in a normal state with a similar fixed camera.

In this case, the region extraction module 106 extracts a second region in the same range as the first region from the normal image acquired in step S4 (step S5).

Next, the text generation module 107 generates a first text and a second text by using the first region extracted in step S3, the second region extracted in step S5, and the generation model stored in the second model storage 103 (step S6).

Here, it is assumed that the generation model in the present embodiment is a trained model obtained by performing training such that the question answering technique can be implemented. Although a learning method of the generation model is not limited, the generation model may be configured to output, for example, when an image is input, an answer according to the image to a question sentence prepared in advance.

According to such a generation model, the text generation module 107 can generate the first text expressing the inside of the first region based on the answer to the question sentence that is output from the generation model, for example, by inputting the first region (a part of the inspection target image) to the generation model. Similarly, the text generation module 107 can generate the second text expressing the inside of the second region based on the answer to the question sentence that is output from the generation model, for example, by inputting the second region (a part of the normal image) to the generation model.

Note that the question sentence used to generate the first text and the question sentence used to generate the second text are the same. Further, the question sentence may be created, for example, by the user, but the question sentence may be generated using a generation model or the like in order to reduce a burden on the user to create the question sentence.

In addition, in the present embodiment, it has been described that the first text and the second text are generated using the generation model. On the other hand, the present embodiment may adopt a configuration in which the first text and the second text expressing the inside of the first region and the inside of the second region can be generated, and the first text and the second text may be generated by a method other than the generation model.

When processing of step S6 is executed, the state determination module 108 determines (specifies) a state of the inspection target included in the inspection target image based on the first text and the second text generated in step S6 (step S7).

Note that, although details will be described later, for example, in a case where a state of the inspection target cannot be determined without comparing the inspection target image (first region) and the normal image (second region), processing of step S7 is executed using, for example, a difference between the first text and the second text (that is, an answer difference between the states of the insides of the first region and the second region).

On the other hand, for example, in a case where the state of the inspection target can be determined from the inspection target image (first region), the processing of step S7 may be executed using only, for example, the first text (the state of the inside of the first region).

When the processing of step S7 is executed, the output module 109 outputs a determination result in step S7 (step S8). Note that the determination result (that is, the state of the inspection target) output in step S8 corresponds to the content of the abnormality occurring in the inspection target. In step S8, the determination result may be output to the communication device 10d to be transmitted to, for example, a server apparatus or the like outside the information processing apparatus 10, or may be output to a display device (for example, a display) to be presented to the user. Note that, in step S8, for example, a position (that is, information related to a location of the abnormality) of the first region in the inspection target image may be output together with the determination result (that is, the content of the abnormality). In a case where the position of the first region is output to the display device, the position of the first region can be displayed, for example, on the inspection target image.

According to the processing illustrated in FIG. 3 described above, it is possible to specify an occurrence position and an occurrence range of the abnormality by performing abnormality detection (generating an abnormality score map) on the inspection target image, and to specify the content of the abnormality (the state of the inspection target) from the answer to the question in the question answering technique.

Here, in step S4 described above, a plurality of normal images may be acquired. In this case, it is possible to specify the content of the abnormality occurring in the inspection target based on, for example, the first text expressing the inside of the first region extracted from the inspection target image and a plurality of second texts (that is, a plurality of second texts generated for each normal image) expressing the insides of the second regions extracted from each of the plurality of normal images. Specifically, a state of the inspection target may be determined a plurality of times based on the first text and each of the plurality of second texts, and the content of the abnormality occurring in the inspection target may be specified by majority decision of the determination results. According to such a configuration, for example, even in a case where a normal image that is not appropriate (a normal image in which the inspection target is not appropriately imaged) is stored in the image storage 102, it is possible to prevent a decrease in the accuracy of specifying the content of the abnormality by considering other normal images.

In addition, in step S4, it has been described that a normal image is acquired, but an abnormal image (an image including the inspection target in an abnormal state) may be acquired instead of the normal image. In a case of such a configuration, it is possible to specify the content of the abnormality occurring in the inspection target by comparing the inspection target image with the abnormal image. Further, both the normal image and the abnormal image may be acquired in step S4. In this case, it is possible to specify the content of the abnormality occurring in the inspection target based on a plurality of second texts expressing the insides of the second regions extracted from each of the abnormal image and the normal image.

Further, in the present embodiment, the abnormality detection module 105 can determine whether or not an abnormality has occurred in the inspection target based on the abnormality score assigned in the abnormality score map generated in step S2. Specifically, for example, the abnormality detection module 105 compares a maximum value of the abnormality score assigned in the abnormality score map with a threshold value prepared in advance (a threshold value for distinguishing a normality and an abnormality), and determines that an abnormality has occurred in the inspection target in a case where the maximum value of the abnormality score is equal to or higher than the threshold value. On the other hand, in a case where the maximum value of the abnormality score is lower than the threshold value, the abnormality detection module 105 determines that no abnormality has occurred in the inspection target. In such a configuration, for example, in a case where it is determined that an abnormality has occurred in the inspection target, processing subsequent to step S3 may be executed, and in a case where it is determined that no abnormality has occurred in the inspection target, processing subsequent to step S3 may not be executed (that is, the processing illustrated in FIG. 3 is ended).

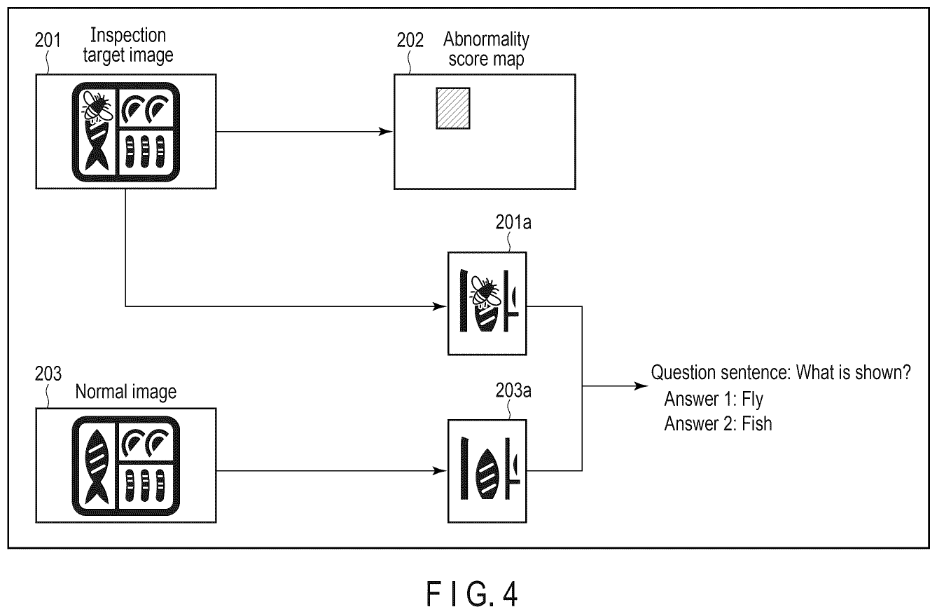

Here, an operation of the information processing apparatus 10 according to the present embodiment will be specifically described with reference to FIG. 4. In the present embodiment, it is assumed that the inspection target includes a plurality of objects (that is, a plurality of objects are disposed in the inspection target). Specifically, in the example illustrated in FIG. 4, the inspection target is a food item, and foods or ingredients such as fish, kamaboko, and sausages are disposed in the food item.

First, as illustrated in FIG. 4, in a case where an inspection target image 201 obtained by imaging the food item that is an inspection target with a fixed camera is acquired, an abnormality score map 202 is generated using the inspection target image 201 and the abnormality detection model.

Here, in a case where a foreign matter (for example, a fly) is mixed at a head position of a fish included in the food item, an abnormality score map 202 is generated in which a higher abnormality score is assigned to a region corresponding to the foreign matter than to other regions. According to such an abnormality score map 202, the first region 201a having a high abnormality score is extracted from the inspection target image 201 (that is, a partial image corresponding to the first region 201a is cut out). In addition, a second region 203a in the same range as the first region 201a is extracted from the normal image 203 (that is, a partial image corresponding to the second region 203a is cut out). Note that the first region 201a and the second region 203a are, for example, rectangular regions.

Next, a first text expressing the inside of the first region 201a is generated using the first region 201a, the question sentence prepared in advance, and the generation model. Similarly, a second text expressing the inside of the second region 203a is generated using the second region 203a, the question sentence prepared in advance, and the generation model.

In the example illustrated in FIG. 4, the question sentence is “What is shown?”, the first text (that is, an answer 1 to the question sentence) is “fly”, and the second text (that is, an answer 2 to the question sentence) is “fish”.

According to the first text and the second text described above, it is possible to specify the content of the abnormality in which a foreign matter (here, a fly) is mixed at the position of the first region 201a of the food item included in the inspection target image.

Note that a case of specifying the content of the abnormality based on a difference between the first text and the second text has been described. On the other hand, for example, in a case where the information processing apparatus 10 (the state determination module 108) recognizes an abnormality indicating that a fly is mixed in a food item that is an inspection target, it is also possible to specify the content of the abnormality from only the first text (that is, a fly is shown in the first region 201a) described above. In other words, for example, in a case where the purpose is to specify mixing of a foreign matter into a food item, it is only necessary to specify the content of the abnormality by using the first text (determine a state of the inspection target), and thus, the processing of extracting the second region 203a from the normal image 203 and generating the second text may be omitted.

Furthermore, as an example different from the example illustrated in FIG. 4, in a case of specifying the content of the abnormality indicating that there is a scratch in a food or an ingredient (for example, kamaboko and the like) included in the food item, a first text may be generated by using the first region including the kamaboko, the question sentence “Is there a scratch on the object shown?”, and the generation model. In this case, in a case where the first text is, for example, “Yes (that is, there is a scratch)”, it is possible to specify that there is a scratch on the kamaboko.

Note that, in a case of specifying the content of the abnormality in a wide range, the content of the abnormality may be specified based on a plurality of texts generated using a plurality of question sentences such as “What is shown?” and “Is there a scratch on the object shown?” described above. Further, for example, it may be determined whether or not the content of the abnormality is specified based on the text generated using a predetermined question sentence, and in a case where the content of the abnormality is not specified, a text may be further generated using the next question sentence.

Further, in the example illustrated in FIG. 4, it is assumed that the inspection target image 201 and the normal image 203 are images obtained by imaging the inspection target (food item) with a fixed camera (that is, the inspection target is imaged from the same position). On the other hand, in a case where a positional relationship between the inspection target and the fixed camera is deviated (that is, a positional deviation of the inspection target occurs between the inspection target image 201 and the normal image 203), a different portion (position) of the inspection target may be shown in each of the first region 201a and the second region 203a, and this may result in a decrease in the accuracy of specifying the content of the abnormality based on a difference between the first text and the second text.

Therefore, in the present embodiment, for example, before the processing of extracting the second region 203a is executed, processing of correcting a positional deviation from the inspection target image 201 (that is, a positional deviation of the inspection target in the image) occurring in the normal image 203 may be executed. Such correction of the positional deviation is implemented, for example, by extracting feature points representing features of the inspection target from each of the inspection target image 201 and the normal image 203 and executing image processing of matching the corresponding feature points between the images (that is, matching a position of the inspection target included in the normal image 203 with a position of the inspection target included in the inspection target image 201).

In this case, the second region 203a may be extracted from the normal image 203 in which the positional deviation is corrected as described above.

As described above, the information processing apparatus 10 according to the present embodiment acquires an inspection target image (first image) including an inspection target, calculates an abnormality score indicating a degree of abnormality for each region included in the inspection target image by using the acquired inspection target image and the abnormality detection model generated by performing training on a normal image (an image including an inspection target in a normal state), and generates an abnormality score map in which the calculated abnormality score is assigned to the corresponding region. Further, the information processing apparatus 10 according to the present embodiment extracts the first region from the inspection target image based on the generated abnormality score map, and generates the first text expressing the inside of the extracted first region. Furthermore, the information processing apparatus 10 according to the present embodiment specifies the content of the abnormality occurring in the inspection target based on the generated first text, and outputs the specified content of the abnormality.

In the present embodiment, with the above-described configuration, it is possible to specify the content of the abnormality, as compared with an abnormality detection method which uses an abnormality detection model generated by performing unsupervised learning and in which it is generally difficult to specify the content of the abnormality.

Specifically, in the present embodiment, a range of the abnormality is extracted (specified) using the abnormality score map, and then the content of the abnormality is specified based on the text generated by applying the question answering technique. According to this configuration, it is not necessary to prepare a question sentence for specifying a location of the abnormality (that is, the question design procedure can be omitted), and thus, it is possible to efficiently detect an abnormality.

In the present embodiment, it is assumed that an abnormality score having a higher value is calculated as the degree of abnormality increases, and a first region including a region to which an abnormality score equal to or higher than a predetermined value is assigned in the abnormality score map is extracted from the inspection target image.

On the other hand, the first region in the present embodiment may be a region extracted from a different viewpoint. Specifically, the first region may be, for example, a region changed (for example, enlarged, reduced, or the like) from the region to which an abnormality score equal to or higher than a predetermined value is assigned. Furthermore, for example, in a case where the value of the abnormality score decreases as the degree of abnormality increases, a first region including a region to which an abnormality score lower than a predetermined value is assigned in the abnormality score map may be extracted from the inspection target image.

Further, in the present embodiment, it is assumed that the first region extracted from the inspection target image is, for example, a rectangular region. On the other hand, the shape of the first region may be a shape other than a rectangle, or may be, for example, a shape determined according to (the shape of) the inspection target.

Furthermore, in the present embodiment, the first text expressing the inside of the first region can be generated by inputting the first region into a generation model called a base model. Note that this generation model (base model) is configured to output, for example, in a case where the first region is input, an answer according to the first region to a question sentence prepared in advance, and the first text can be generated based on the answer output from the generation model. The question sentence to be used for generating the first text may be selected according to the test target from, for example, a large number of question sentences prepared in advance, and the first text may be generated based on the answer output from the generation model by inputting the first region and the selected question sentence to the generation model.

Note that the present embodiment may adopt a configuration in which the first text is generated from the first region. For example, the first text may be generated by executing image processing on the first region.

Furthermore, the information processing apparatus 10 according to the present embodiment may be configured to extract the second region corresponding to the first region from the normal image prepared in advance (the second image including the inspection target), further generate the second text expressing the inside of the extracted second region, and specify the content of the abnormality occurring in the inspection target based on the difference between the first text and the generated second text. According to such a configuration, it is possible to specify the content of the abnormality occurring in the inspection target with higher accuracy as compared with a case where only the first text (first region) is used. On the other hand, for example, in a case where the processing amount in the information processing apparatus 10 is reduced, a configuration of specifying the content of the abnormality occurring in the inspection target by using only the first text may be adopted. Further, whether to use only the first text or to use the first text and the second text when specifying the content of the abnormality occurring in the inspection target may be appropriately selected according to, for example, the inspection target.

Further, in the present embodiment, a positional deviation of the normal image from the inspection target image may be corrected based on the inspection target image and the feature points extracted from the normal image, the normal image being an image from which the second region to be used to generate the second text is extracted. In this case, the second region is extracted from the normal image in which the positional deviation is corrected. In the present embodiment, with such a configuration, the same portion of the inspection target is included in the first region and the second region as described above. Thus, it is possible to improve the accuracy of specifying the content of the abnormality occurring in the inspection target.

Note that, in the present embodiment, it has been described that the second region is extracted from the normal image. On the other hand, the second region may be extracted from each of a plurality of normal images, may be extracted from at least an abnormal image (an image including the inspection target in an abnormal state), or may be extracted from each of the normal image and the abnormal image.

That is, the present embodiment may adopt a configuration in which the content of the abnormality occurring in the inspection target may be specified from a difference (answer difference) between the first text and each of a plurality of second texts obtained using the plurality of images in the image storage 102 (image database).

Furthermore, in the present embodiment, it has been described that the content of the abnormality specified based on, for example, the first text and the like (that is, the content of the abnormality occurring in the inspection target) is output. On the other hand, in addition to the content of the abnormality, other information such as a position of the first region in the inspection target image (that is, a location where the abnormality occurs in the inspection target) may be further output.

Note that, in the present embodiment, it has been described that the information processing apparatus 10 includes the modules 101 to 109 illustrated in FIG. 1. On the other hand, the configuration of the information processing apparatus 10 may be different from the configuration in FIG. 1. Specifically, the information processing apparatus 10 according to the present embodiment may have a configuration in which at least some of the modules 101 to 109 illustrated in FIG. 1 are disposed outside, or may have a configuration further including functional modules other than the modules 101 to 109. Furthermore, the information processing apparatus 10 according to the present embodiment may be implemented in a form of an information processing system or the like including a first apparatus including a part of the modules 101 to 109 illustrated in FIG. 1 and a second apparatus including the other part of the modules 101 to 109.

### Second Embodiment

Next, a second embodiment will be described. Note that, in the present embodiment, a description of the same parts as the parts of the first embodiment described above will be omitted, and parts different from the parts of the first embodiment will be mainly described.

Here, in the first embodiment described above, it has been described that the first region including the region to which the abnormality score equal to or higher than the predetermined value is assigned in the abnormality score map is extracted from the inspection target image. On the other hand, in such a first region, the accuracy of specifying the content of the abnormality occurring in the inspection target may be lowered.

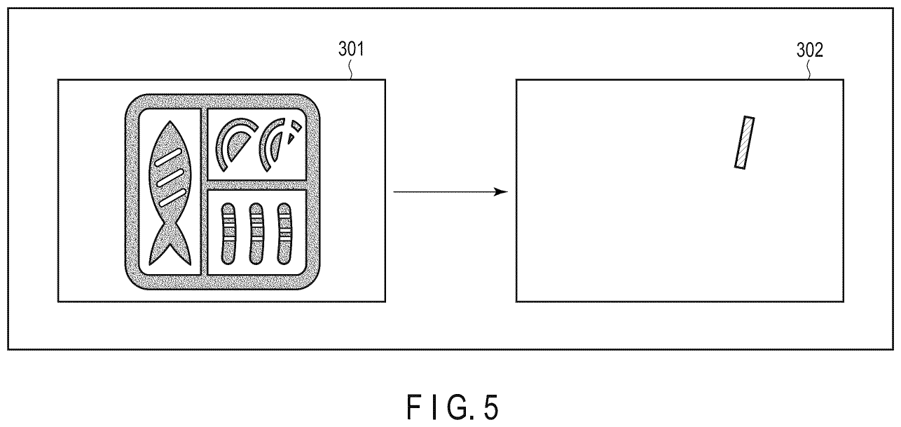

Specifically, as illustrated in FIG. 5, for example, in a case where a food item such as a kamaboko that has a scratch on a part is an inspection target, the abnormality score map 302 is generated from the inspection target image 301 including the food item.

In this case, in the abnormality score map 302, a high abnormality score is assigned to a scratch portion of the kamaboko, and the first region including a region having a high abnormality score is extracted from the inspection target image 301.

On the other hand, there is a case where the first region extracted from the inspection target image 301 based on the abnormality score map 302 is a smaller region than the kamaboko itself, and an appropriate text may not be generated even in a case where the question answering technique is applied to the first region.

Therefore, unlike the first embodiment described above, the present embodiment adopts a configuration in which a region including an object is extracted as the first region.

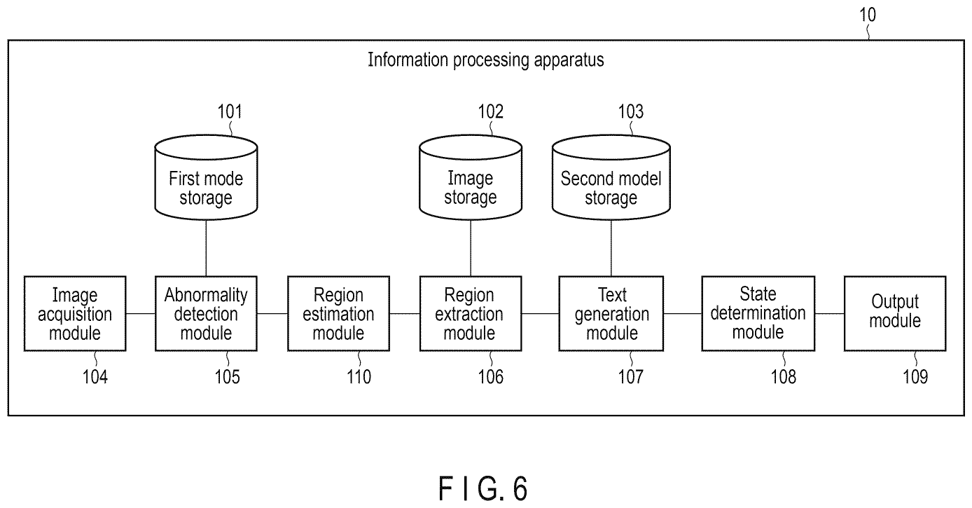

FIG. 6 is a block diagram illustrating an example of a functional configuration of the information processing apparatus according to the present embodiment. In FIG. 6, the same reference numerals are given to the same parts as those in FIG. 1 described above, and a detailed description thereof will be omitted.

As illustrated in FIG. 1, the information processing apparatus 10 includes a region estimation module 110. The region estimation module 110 specifies an object to which a high abnormality score is assigned among objects included in the inspection target image based on the abnormality score map generated by the abnormality detection module 105, and estimates a region including the specified object (hereinafter, referred to as an object region).

In the present embodiment, the region extraction module 106 extracts, as the first region, the object region estimated by the region estimation module 110 from the inspection target image.

Note that the hardware configuration of the information processing apparatus 10 is similar to the configuration of FIG. 2 described above, and thus, a detailed description thereof will be omitted here. A part or the entire of the region estimation module 110 in the present embodiment is implemented by causing the CPU 10a to execute a predetermined program (that is, software). On the other hand, the region estimation module 110 may be implemented by hardware or a combination of software and hardware.

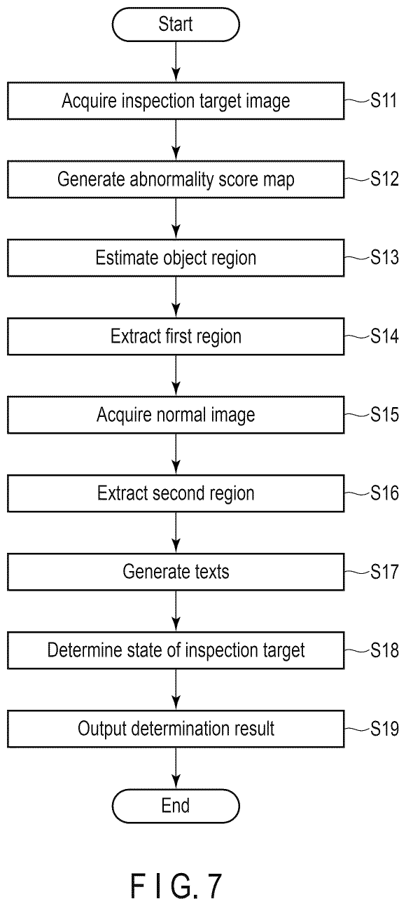

Hereinafter, an example of a processing procedure of the information processing apparatus 10 according to the present embodiment will be described with reference to the flowchart of FIG. 7.

First, processing of step S11 and step S12 corresponding to the processing of step S1 and step S2 illustrated in FIG. 3 described above is executed.

Next, the region estimation module 110 estimates an object region in which an abnormality is found in the inspection target image (that is, an object region) based on a region having a high abnormality score in the abnormality score map generated in step S12 (step S13). In step S13, an object overlapping with a region to which an abnormality score equal to or higher than a predetermined value is assigned in the abnormality score map is specified, and an object region is estimated based on the specified object. Note that the object region may be a rectangular region or a region having a shape along a contour of the object. Further, the object may be specified by using, for example, a technique such as GrabCut or a segment anything model (SAM).

The region extraction module 106 extracts the first region from the inspection target image based on, for example, the object region estimated in step S13 (step S14).

When processing of step S14 is executed, processing of step S15 to step S19 corresponding to the processing of step S4 to step S8 illustrated in FIG. 3 described above is executed.

Note that, although not illustrated in FIG. 7, the processing of correcting the positional deviation described in the first embodiment may be executed between the processing of step S15 and the processing of step S16.

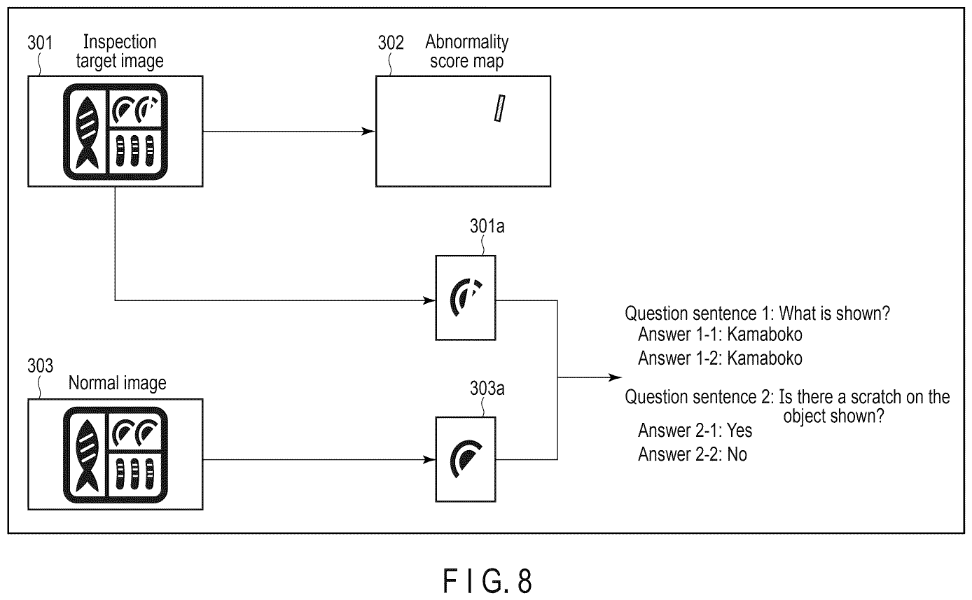

Here, an operation of the information processing apparatus 10 according to the present embodiment will be specifically described with reference to FIG. 8. It is assumed that the inspection target in the example illustrated in FIG. 8 is a food item described in FIG. 4 described above.

First, as illustrated in FIG. 8, in a case where an inspection target image 301 obtained by imaging a food item with a fixed camera is acquired, an abnormality score map 302 is generated by using the inspection target image 301 and the abnormality detection model.

Here, in a case where there is a scratch on a part of the kamaboko included in the food item, the abnormality score map 302 is generated in which a higher abnormality score is assigned to the region corresponding to the scratch than the other regions.

In this case, the kamaboko is specified as the object overlapping with the region to which a high abnormality score is assigned in the abnormality score map 302, and the object region including the kamaboko is estimated. In the present embodiment, the object region estimated in this way is set as the first region 301a, and is extracted from the inspection target image 301. In addition, the second region 303a in the same range as the first region 301a (object region) is extracted from the normal image 303. Note that the first region 301a and the second region 303a are, for example, rectangular regions.

Next, the first text expressing the inside of the first region 301a is generated using the first region 301a, the question sentence prepared in advance, and the generation model. Similarly, the second text expressing the inside of the second region 303a is generated using the second region 303a, the question sentence prepared in advance, and the generation model.

In the example illustrated in FIG. 8, the question sentence 1 is “What is shown?”, the first text (that is, an answer 1-1 to the question sentence 1) is “kamaboko”, and the second text (that is, an answer 1-2 to the question sentence 1) is “kamaboko”.

Further, in the example illustrated in FIG. 8, the question sentence 2 is “Is there a scratch on the object shown?”, the first text (that is, an answer 2-1 to the question sentence 2) is “Yes”, and the second text (that is, an answer 2-2 to the question sentence 2) is “No”.

According to the first text and the second text described above, it is possible to specify the content of the abnormality indicating that there is a scratch on the kamaboko disposed at the position of the first region 301a, rather than mixture of a foreign matter.

Note that, in the present embodiment, since the object region is extracted as the first region 301a and the second region 303a from the inspection target image 301 and the normal image 303, the answers 1-1 and 1-2 to the question sentence 1 are “kamaboko” (that is, the object included in the first region 301a and the second region 303a can be recognized). On the other hand, for example, in a case where only the scratch portion of the kamaboko (that is, a part of the kamaboko) is extracted as the first region and the second region, the answer according to the first region and the second region may not be “kamaboko”, and inappropriate content of the abnormality may be specified.

On the other hand, in the present embodiment, the object region (the first region 301a and the second region 303a) is extracted instead of a simple abnormality range (a region having a high abnormality score), and the question answering technique is applied to the object region. Therefore, it is possible to specify the content of the abnormality occurring in the inspection target with high accuracy.

According to at least an embodiment described above, it is possible to provide an information processing apparatus, an information processing method, and a program capable of specifying the content of the abnormality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor configured to:
acquire a first image including an inspection target;
calculate an abnormality score representing a degree of abnormality for each region included in the first image by using the acquired first image and an abnormality detection model generated by performing training on an image including an inspection target in a normal state;
generate an abnormality score map in which the calculated abnormality score is assigned to the region;
extract a first region from the first image based on the generated abnormality score map;
generate a first text expressing an inside of the extracted first region;
specify content of an abnormality occurring in the inspection target based on the generated first text; and
output the specified content of the abnormality.

2. The information processing apparatus according to claim 1, wherein
the first region includes a region to which an abnormality score equal to or higher than a predetermined value is assigned in the generated abnormality score map.

3. The information processing apparatus according to claim 1, wherein
the first region includes a region including an object to which an abnormality score equal to or higher than a predetermined value is assigned in the generated abnormality score map.

4. The information processing apparatus according to claim 1, wherein
the first region is a rectangular region.

5. The information processing apparatus according to claim 1, wherein
the first text is generated by inputting the extracted first region to a base model.

6. The information processing apparatus according to claim 5, wherein
the base model is configured to output, in a case where the first region is input, an answer according to the first region to a question sentence prepared in advance, and
the first text is generated based on the answer output from the base model.

7. The information processing apparatus according to claim 1, wherein
the processor is configured to:
extract a second region corresponding to the extracted first region from a second image which includes the inspection target and is prepared in advance;
generate a second text expressing an inside of the extracted second region; and
specify the content of the abnormality occurring in the inspection target based on a difference between the generated first text and the generated second text.

8. The information processing apparatus according to claim 7, wherein
a positional deviation of the second image from the first image is corrected based on feature points extracted from the first image and the second image, and
the processor is configured to extract the second region from the second image in which the positional deviation is corrected.

9. The information processing apparatus according to claim 7, wherein
the second image includes at least an image including an inspection target in a normal state or an image including an inspection target in an abnormal state.

10. The information processing apparatus according to claim 1, wherein
the processor is configured to output a position of the first region in the first image.

11. An information processing method executed by an information processing apparatus, the information processing method comprising:
acquiring a first image including an inspection target;
calculating an abnormality score representing a degree of abnormality for each region included in the first image by using the acquired first image and an abnormality detection model generated by performing training on an image including an inspection target in a normal state;
generating an abnormality score map in which the calculated abnormality score is assigned to the region;
extracting a first region from the first image based on the generated abnormality score map;
generating a first text expressing an inside of the extracted first region;
specifying content of an abnormality occurring in the inspection target based on the generated first text; and
outputting the specified content of the abnormality.

12. A non-transitory computer-readable storage medium having stored thereon a program which is executed by a computer of an information apparatus, the program comprising instructions capable of causing the computer to execute function of:
acquiring a first image including an inspection target;
calculating an abnormality score representing a degree of abnormality for each region included in the first image by using the acquired first image and an abnormality detection model generated by performing training on an image including an inspection target in a normal state;
generating an abnormality score map in which the calculated abnormality score is assigned to the region;
extracting a first region from the first image based on the generated abnormality score map;
generating a first text expressing an inside of the extracted first region;
specifying content of an abnormality occurring in the inspection target based on the generated first text; and
outputting the specified content of the abnormality.
